(19) United States
(12) Patent Application Publication
(10) Pub. No.: US 2016/0162937 A1
(43) Pub. Date: Jun. 9, 2016

(54) METHOD AND SYSTEM FOR IDENTIFYING USERS ACROSS MULTIPLE COMMUNICATION DEVICES

(71) Applicant: Hitesh Chawla, San Francisco, CA (US)

(72) Inventor: Hitesh Chawla, San Francisco, CA (US)

(21) Appl. No.: 14/561,584

(22) Filed: Dec. 5, 2014

(51) Int. Cl. G06Q 30/02

(52) U.S. Cl. CPC G06Q 30/0255; G06Q 30/0277

(57) ABSTRACT

A method and system for identifying users across multiple communication devices. The method includes creating a first dataset of communication devices, where the first dataset includes at least one device identification number, one or more device details and one or more user behaviour information. Further, the method includes creating a second dataset of communication devices, where the second dataset includes one or more cookie identification numbers, one or more device details and one or more user behavior information. Further, the method includes correlating the first dataset and the second dataset to statistically determine a plurality of matching communication devices of the unique user, where the correlation is based on the one or more device details and the one or more user behavior details. Finally, the method includes storing the plurality of matching communication devices in a third dataset.

### CROSS REFERENCE TO RELATED APPLICATION

This application claims priority under 35 USC 119 (e) to US Provisional Patent Application Ser. No. 61/913,270 filed, Dec. 7, 2013 with the Title: ‘Method and System for Advertisement Re-Targeting on a Communication Device” which is incorporated herein by reference in its entirety.

### FIELD OF THE INVENTION

The present invention is generally related to advertising of products and services on the Internet. More particularly, the invention relates to a method and system for identifying users across multiple communication devices

### BACKGROUND OF THE INVENTION

The advent of the internet has facilitated speedier communication between persons and entities. Advertisements for products and service which were limited to paper and billboards in yester years has given way to advertisements through the worldwide web (www) reaching the masses in a matter of seconds. The internet era has also produced a plethora of devices that enable users to access the internet to communicate with each other and compare products and services offered by the various entities through their advertisements. These days it is common to see users carrying one or more smart devices such as a mobile phone, laptop, tablet and/or other such smart devices when they are mobile. When at home or at their business, a desktop or TV may inundate a user with advertisements for products and services. Advertisers seeking to target users based on their behaviour and buying habits generally have access to that behaviour data on these multiple communication devices only through data generated by each device, individually. For instance, an advertiser may have access to the behaviour data of a user through his mobile phone, but has no way of knowing if it is the same user's behaviour the advertiser has access to through his laptop behaviour data. Similarly, an advertiser may not be able to re-target a user on a different communication device, based on his behaviour on one communication device. For instance, it may not be possible to re-target a user who browses for shoes on his laptop with advertisements of shoes on his mobile phone. Further, it is not possible to re-target a user between a browser and an app on a mobile device.

The primary reason for the difficulty in re-targeting users through their individual smart devices is due to the fact that the personal identifiable information is not available for the users and each of these devices is identified by one or more permanent or temporary unique IDs (identifications). Examples of unique IDs include, but are not limited to Apple IDFA, Android ID, Android IDA, UDID, MAC ID, IMEI, MISISDN, cookie ID, and Open-UDID. The unique ID of one device cannot be linked to the unique ID of another communication device. Therefore, ensuring relevance of marketing messaging across multiple devices is among one of the biggest dilemmas and a source of frustration for advertisers everywhere. Prior art to date have not addressed the need for identifying users across multiple devices so that advertisers can easily re-target users on their devices.

Therefore and accordingly, there is a need in the prior art for a method and system that can re-target users across multiple devices. In addition, there is a need for a method and system for identifying users across multiple communication devices.

### SUMMARY OF THE INVENTION

It is an object of the present invention to provide a method and system for advertisement re-targeting on a communication device.

It is yet another object of the present invention to provide a method and system for matching a user between applications installed on a communication device and browsers on the communication device.

It is yet another object of the present invention to provide a method and system for identifying users across multiple communication devices

These and other objects of the present invention are achieved by providing a method and system for identifying users across multiple communication devices. The method includes creating a first dataset of communication devices, where the first dataset includes at least one device identification number, one or more device details and one or more user behaviour information for each communication device of the first dataset of communication devices. The method further includes creating a second dataset of communication devices, where the second dataset includes one or more cookie identification numbers, one or more device details and one or more user behavior information for each communication device of the second dataset of communication device. Further, the method includes correlating the first dataset and the second dataset to statistically determine a plurality of matching communication devices of the unique user, where the correlation is based on the one or more device details and the one or more user behavior details. Finally, the method includes storing the plurality of matching communication devices in a third dataset of communication devices.

The objects of the invention thus described in this summary of the invention will be best understood through the accompanying drawings, detailed description of the invention and the claims.

### BRIEF DESCRIPTION OF THE DRAWINGS

FIG. 1 shows an environment in which various embodiments of the present invention can be practiced.

FIG. 2 shows a block diagram of a system for identifying users across multiple communication devices, in accordance with an embodiment of the present invention.

FIG. 3 shows a block diagram of a system for identifying users across multiple communication devices, in accordance with another embodiment of the present invention.

FIG. 4 shows a flow chart of a method for identifying a unique user across multiple communication devices, in accordance with an embodiment of the present invention.

FIG. 5 shows a flow chart of a method for identifying a unique user across multiple communication devices, in accordance with another embodiment of the present invention.

FIG. 6 shows a retargeting system for the implementation of the present invention, in accordance with an embodiment of the present invention.

Those skilled in the relevant art will appreciate that elements in the figures are illustrated for simplicity and clarity and not necessarily drawn to scale. For example, the dimensions of some of the elements in the figures may be exaggerated relative to other elements to provide clarity and understanding of the embodiments of the present invention.

### DETAILED DESCRIPTION OF THE INVENTION

The present invention provides a method and system for advertisement re-targeting on a communication device. The invention also provides a method and system for matching a user between applications installed on a communication device and browsers on the communication device as well as, a method and system for identifying users across multiple communication devices.

The present invention resides primarily in combinations with method and system components related to computing devices. Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this specification and claims of the invention, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

The terms “mobile device” and “communication device” have been used interchangeably, and refer to any computing device which has the capability of communicating or interacting with its users.

The present invention provides a method and system for identifying users across multiple communication devices. The method includes creating a first dataset of communication devices, where the first dataset includes at least one device identification number, one or more device details and one or more user behaviour information for each communication device of the first dataset of communication devices. The method further includes creating a second dataset of communication devices, where the second dataset includes one or more cookie identification numbers, one or more device details and one or more user behavior information for each communication device of the second dataset of communication device. Further, the method includes correlating the first dataset and the second dataset to statistically determine a plurality of matching communication devices of the unique user, where the correlation is based on the one or more device details and the one or more user behavior details. Finally, the method includes storing the plurality of matching communication devices in a third dataset of communication devices.

The present invention further provides a method and system for advertisement retargeting on a communication device. The method includes receiving a request for a bid for an advertisement on the communication device, where the request includes one or more device identification details of the communication device. The method further includes matching the one or more device identification details with the plurality of advertiser devices, where the advertiser devices are the devices which accessed at least one of advertiser website or advertiser application. Further, the method includes finding a match for the communication device, where finding the match includes a match factor. Further, the method includes adjusting bid amount based on the match factor. Finally, the method includes sending the bid for the request.

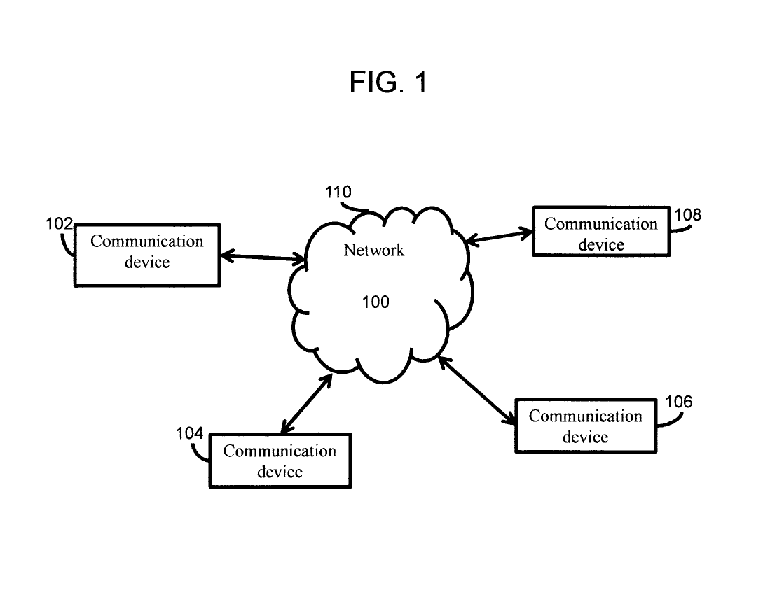

Referring now to the drawings, more particularly to FIG. 1 the figure shows an environment 100 in which various embodiments of the present invention can be practiced. The environment 100 includes a plurality of communication devices 102, 104, 106 & 108 being used by a user via a network 110. In the present invention, a communication device can be any device capable of communicating through a network. Examples of the plurality of communication devices 102, 104, 106 & 108 include, but are not limited to, a computer, a laptop, a server, a mobile phone, a tablet PC, a netbook, an e-book reader, an embedded computing device and/or a PDA (personal digital assistant). The network 110 is one or more of a Wi-Fi network, a cellular network, a 2G network, a 3G network, a 4G network, and an Internet network. The user may use each communication device of the plurality of communication devices via any network available to the user.

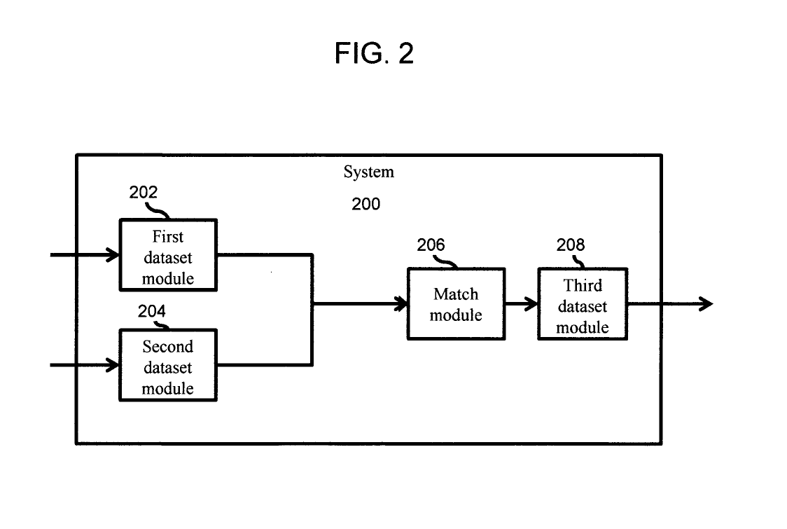

FIG. 2 shows a block diagram of a system 200 for identifying users across multiple communication devices, in accordance with an embodiment of the present invention. The system 200 includes a first dataset module 202, a second dataset module 204, a match module 206, and a third dataset module 208. The first dataset module 202 creates a first dataset of communication devices. In an embodiment of the present invention, the first dataset is created from at least one of one or more advertisement exchanges, one or more data exchanges, one or more offline datasets and one or more installed applications. For each communication device of the first dataset of communication devices, the first dataset includes at least one device identification number, one or more device details and one or more user behaviour information. Examples of the at least one device identification number includes, but is not limited to, IMEI number, MAC address ID, Android ID, Android Advertiser Identifier, ODIN (Open Device Identification Number), MSISDN ID, IDFA, UDID (Unique Device Identifier), a manufacturer provided ID and a third party unique ID. Examples of the one or more device details include, but are not limited to, http headers, browser user agent, IP address, network SSID (Service Set Identifier), screen resolution, location, browser plugins, flash version, JavaScript support, device manufacturer, device model, do not track status, device language and browser fonts. Examples of the one or more behavior information include, but are not limited to, time of the day, day of the week, date, number of sessions, average time per session, referral URL, user intent, user sentiment, gender, age, events, and category of page browsed by a user.

Further, the second dataset module 204 creates a second dataset of communication devices. For each communication device in the second dataset of communication devices, the second dataset includes one or more cookie identification numbers, one or more device details and one or more user behavior information. The cookie identification number is a unique identification number generated for a new cookie dropped on a communication device. The cookie identification number stays unique for a browser on the communication device, as long as the dropped cookie is present on the communication device. Multiple browsers on the communication device can have multiple unique identification numbers.

Further, the match module 206 correlates the first dataset and the second dataset to statistically determine a plurality of matching communication devices of the unique user. The correlation is based on the one or more device details and the one or more user behavior details. In an embodiment of the present invention, the match module 206 correlates the first dataset and the second dataset using one or more machine learning models. Examples of the one or more machine learning models include, but are not limited to, Collaborative Filtering, K-nearest neighbor, and cosine similarity. The one or more machine learning models are provided with training data, where the training data includes correlated communication devices with confirmed match probability. An example of the training data with confirmed match probability includes, but is not limited to, data correlated using email ids of users.

Finally, the third dataset module 208 stores the correlated data in a third dataset for the matched communication devices along with the match probability.

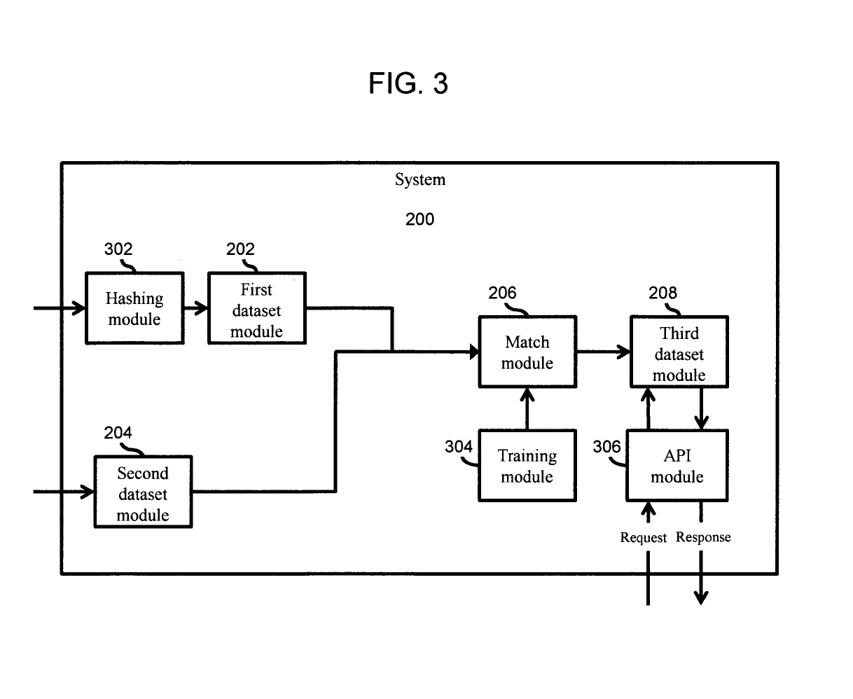

FIG. 3 shows a block diagram of a system 200 for identifying users across multiple communication devices, in accordance with another embodiment of the present invention. The system 200 includes a hashing module 302, a first dataset module 202, a second dataset module 204, a match module 206, a training module 304, a third dataset module 208 and an API module 306. The first dataset module 202 creates a first dataset of communication devices. For each communication device of the first dataset of communication devices, the first dataset includes at least one device identification number, one or more device details and one or more user behaviour information. The hashing module 302 hashes the at least one device identification number before it is stored in the first dataset of communication devices. The hashing can be done using one or more hashing techniques. Examples of the one or more hashing techniques include, but are not limited to, MD4, MD5, SHA-1 and SHA-2.

Further, the second dataset module 204 creates a second dataset of communication devices. For each communication device in the second dataset of communication devices, the second dataset includes one or more cookie identification numbers, one or more device details and one or more user behavior information.

Further, the match module 206 correlates the first dataset and the second dataset to statistically determine a plurality of matching communication devices of the unique user. The correlation is based on the one or more device details and the one or more user behavior details. The match module 206 correlates the first dataset and the second dataset using one or more machine learning models. The one or more machine learning models are provided with training data via training module 304, where the training data includes correlated communication devices with confirmed match probability.

Further, the third dataset module 208 stores the correlated data in a third dataset for the matched communication devices along with the match probability.

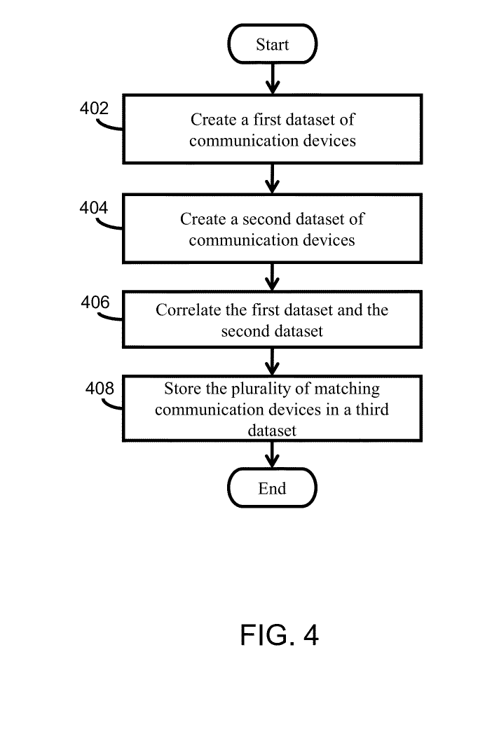

FIG. 4 shows a flow chart of a method for identifying a unique user across multiple communication devices, in accordance with an embodiment of the present invention. At step 402, the system 200 creates a first dataset of communication devices. The first dataset includes at least one device identification number, one or more device details and one or more user behaviour information. Further, at step 404, the system 200 creates a second dataset of communication devices. The second dataset includes one or more cookie identification numbers, one or more device details and one or more user behavior information. Still further, at step 406 the system 200 correlates the first dataset and the second dataset to statistically determine a plurality of matching communication devices of the unique user. The correlation is based on the matching of one or more device details and the one or more user behavior details. Finally, at step 408, the system 200 stores the plurality of matching communication devices in a third dataset.

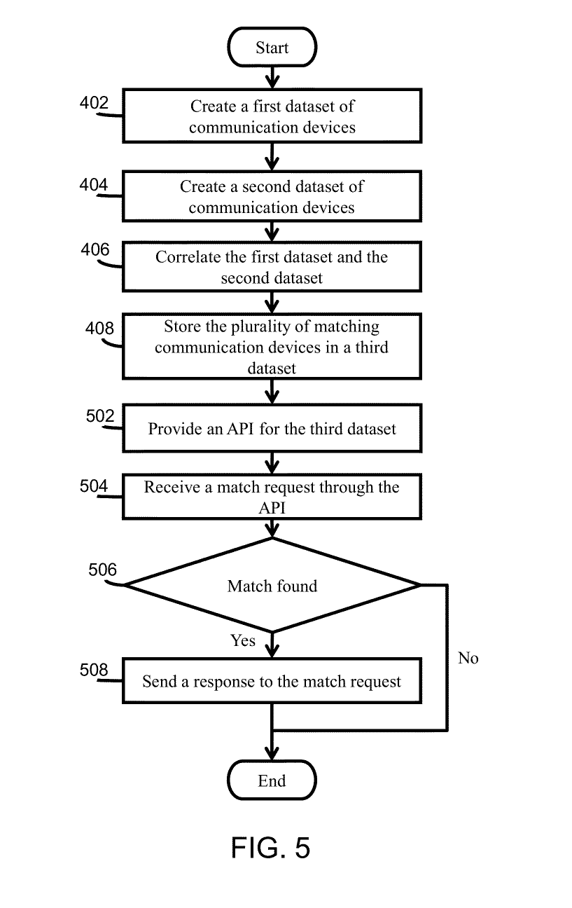

FIG. 5 shows a flow chart of a method for identifying a unique user across multiple communication devices, in accordance with another embodiment of the present invention. At step 402, the system 200 creates a first dataset of communication devices. The first dataset includes at least one device identification number, one or more device details and one or more user behaviour information. In an embodiment of the present invention, the system 200 creates a cryptographic hash of the at least one device identification number before storing in the first dataset. Further, at step 404, the system 200 creates a second dataset of communication devices. The second dataset includes one or more cookie identification numbers, one or more device details and one or more user behavior information. Still further, at step 406 the system 200 correlates the first dataset and the second dataset to statistically determine a plurality of matching communication devices of the unique user. The correlation is based on the matching of one or more device details and the one or more user behavior details. Further, at step 408, the system 200 stores the plurality of matching communication devices in a third dataset. At step 502, the system 200 provides an API for the third dataset. At step 504, the system 200 receives a match request through the API, the match request containing one of a cookie identification number and a device identification number. At step 506, the system 200 checks if there is correlation data available in the third dataset for the match request received. In an embodiment of the present invention, the correlation data is found. At step 508, the system 200 sends a response to the match request, the response containing at least one of the one or more device identification numbers and the one or more cookie identification numbers correlated to the match request. In an embodiment of the present invention, where the response includes match probability of the match between one or more device numbers and one or more cookie identification numbers. In another embodiment of the present invention, the system 200 does not find correlation data in the third dataset. The system 200 then sends one of an empty response, no response and a response containing information on non-availability of data.

In an embodiment of the present invention, a method and system for matching a user across installed applications and browsers on a communication device is provided. The method includes creating a first database of plurality of unique devices, where data of each unique device of the plurality of unique devices includes one or more device identification numbers, one or more device details and one or more user behaviour details of the user of the each unique device. In an embodiment of the present invention, the data includes a fingerprint of the device. The fingerprint can be generated by an embodiment of the present invention, or can be generated by a third party. The data for the first database is created from one or more multiple sources. Examples of the one or more sources include, but are not limited to, from a plurality of bid requests received from one or more advertisement exchanges, from data exchanges and from integration with publishers.

The method further includes creating a second database of plurality of unique devices from a code integrated on one or more websites, where the second database includes one or more cookie identification numbers, one or more device details and one or more user behavior details of the user of the one or more websites. In an embodiment of the present invention, the website data includes a fingerprint of the device. The fingerprint can be generated by an embodiment of the present invention, or can be generated by a third party. Finally, the method includes correlating the first database and the second database based on the one or more device details and one or more user behavior details in the first database and the one or more device details and one or more user behavior details the second database. In an embodiment of the present invention, the fingerprints generated in the first and the second databases are also used for correlating. In an embodiment of the present invention, the correlated data is saved in a third database.

In an embodiment of the present invention, one or more algorithms are used for creating a correlation between the first database and the second database. Examples of the algorithms include, but are not limited to, Collaborative Filtering, K-nearest neighbor, and cosine similarity. The algorithms can be used singly or in a combination. The correlated data/third database are continuously updated using Bayesian updating, as and when more data in the first database and the second database arrives.

The present invention provides a method and system for providing an API (Application Programing Interface) for providing device identification. The method includes receiving a match request through the API, the match request containing a cookie identification number of the one or more cookie identification numbers present in the system. The method further includes finding a matching device identification number for the received cooking identification number in the matched/correlated device database. Finally, the method includes sending a response to the match request, where the response includes a device identification number correlated to the cookie identification number.

In another embodiment of the present invention, the method includes receiving a match request through the API, the match request containing a device identification number of the one or more device identification numbers present in the system. The method further includes finding one or more matching cookie identification numbers for the received device identification number in the matched/correlated device database. Finally, the method includes sending a response to the match request, where the response includes the one or more cookie identification numbers correlated to the device identification number.

The present invention can be used for matching a device identification number of a device to a browser present on the same device or to a browser present on a different device belonging to the same user. This helps in tying up the identity of the user when he moves from browser to app and also when he moves between multiple devices.

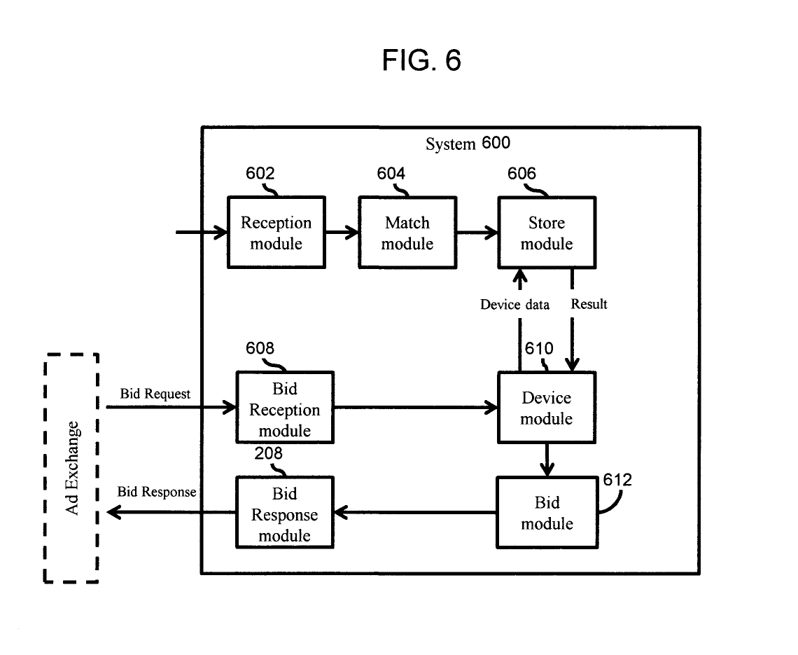

FIG. 6 shows a retargeting system 600 for the implementation of the present invention, in accordance with an embodiment of the present invention. The retargeting system 600 retargets a user through advertisements on a communication device, where the user is retargeted for an advertiser. The reception module 602 receives browsing information of the user, where the browsing information is for a website of the advertiser. The match module 604 then matches the browsing information of the user with a database of devices, where the database includes one or more device identifiers. The store module 606 then stores one or more matched devices of the user in the database of devices, where each of the one or more matched devices includes a probability of the match and the browsing information. The bid reception module 608 receives a bid request from one of one or more advertisement exchanges. The device module 610 searches for a potential match for device information obtained in the bid request in the store module 606. In an embodiment of the present invention, the device module 610 finds a match for the device information in the bid request. The bid module 612 then prepares a bid response, based on the probability of match and the browsing information.

In an embodiment of the present invention, the bid module 612 customizes advertisement creative based on the browsing information of the user. For example, a user looking for shoes on the advertiser website, is shown an advertisement containing same or similar shoes.

In an embodiment of the present invention, the bid module 612 calculates bid price for the bid request based on one of more parameters, where the one or more parameters include the probability of match.

Finally, the bid response module 614 sends a bid response for the bid request, where the bid response includes the calculated bid amount. In an embodiment of the present invention, the system 600 wins the bid request. The system 600 then shows the advertisement creative.

The computer program product of the invention is executable on a computer system to cause the computer system to perform a method for identifying a unique user across multiple communication devices of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN, Wireless, GPRS, Ultra wide band and the Internet. The computer system facilitates inputs from a user through input device, accessible to the system through I/O interface.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the present invention has been thus described in connection with preferred embodiments, it will be understood by those skilled in the art that variations modifications of the preferred embodiments described above may be made without departing from the spirit and scope of the invention. Other embodiments will be apparent to those skilled in the art from a consideration of the specification or from a practice of the invention disclosed herein. It is intended that the specification and the described examples are considered exemplary only, with the true scope of the invention indicated by the appended claims.

What is claimed is:

1. A method for identifying a unique user across multiple communication devices, the method comprising:
creating a first dataset of communication devices, the first dataset comprising at least one device identification number, one or more device details and one or more user behaviour information;
creating a second dataset of communication devices, the second dataset comprising one or more cookie identification numbers, one or more device details and one or more user behavior information;
correlating the first dataset and the second dataset to statistically determine a plurality of matching communication devices of the unique user, the correlation being based on the one or more device details and the one or more user behavior details; and,
storing the plurality of matching communication devices in a third dataset.

2. The method as recited in claim 1, wherein creating the first dataset comprises creating the first dataset from at least one of one or more advertisement exchanges, one or more data exchanges, one or more offline datasets and one or more installed applications.

3. The method as recited in claim 1, wherein storing the plurality of matching communication devices comprising storing the match probability of the plurality of matching communication devices along with one or more identification numbers.

4. The method as recited in claim 1, wherein the at least one device identification number comprises IMEI number, MAC address ID, Android ID, Android Advertiser Identifier, ODIN (Open Device Identification Number), MSISDN ID, IDFA, UDID (Unique Device Identifier), a manufacturer provided ID and a third party unique ID.

5. The method as recited in claim 1 wherein one or more device identification numbers of the at least one device identification number are hashed.

6. The method as recited in claim 1 further comprising hashing the at least one device identification number.

7. The method as recited in claim 1, wherein the one or more device details comprises one or more of http headers, browser user agent, IP address, network SSID (Service Set Identifier), screen resolution, location, browser plugins, flash version, JavaScript support, device manufacturer, device model, do not track status, device language and browser fonts.

8. The method as recited in claim 1, wherein user behavior information comprises one or more of time of the day, day of the week, date, number of sessions, average time per session, referral URL, user intent, user sentiment, gender, age, events, and category.

9. The method as recited in claim 1, wherein correlating the first dataset and the second dataset comprises correlating using one or more machine learning models.

10. The method as recited in claim 9 further comprising providing training data to the one or more machine learning models, the training data including correlated communication devices with confirmed match probability.

11. The method as recited in claim 1 further comprising providing an API (Application Programing Interface) for the third dataset.

12. The method as recited in claim 11 further comprising receiving a match request through the API, the match request containing one of a cookie identification number and a device identification number.

13. The method as recited in claim 12 further comprising sending a response to the match request, the response comprising at least one of the one or more device numbers and the one or more cookie identification numbers correlated to the match request.

14. The method as recited in claim 13, wherein the response comprises match probability.

15. A system for identifying a user across multiple communication devices, the system comprising:
a first dataset module, the first dataset module creating a first dataset of communication devices, where the first dataset comprises of at least one device identification number, one or more device details and one or more user behaviour information;
a second dataset module, the second dataset module creating a second dataset of communication devices, where the second dataset comprises of one or more cookie identification numbers, one or more device details and one or more user behavior information;
a match module, the match module correlating the first dataset and the second dataset to statistically determine a plurality of matching communication devices of the unique user, the correlation being based on the one or more device details and the one or more user behavior details; and,
a third dataset module, the third dataset module storing the plurality of matching communication devices in a third dataset.

16. The system as recited in claim 15, wherein the first dataset module creates the first dataset from at least one of one or more advertisement exchanges, one or more data exchanges, one or more offline datasets and one or more installed applications.

17. The system as recited in claim 15, wherein the third dataset module stores the match probability of the plurality of matching communication devices along with one or more identification numbers.

18. The system as recited in claim 15, wherein the at least one device identification number comprises IMEI number, MAC address ID, Android ID, Android Advertiser Identifier, ODIN (Open Device Identification Number), MSISDN ID, IDFA, UDID (Unique Device Identifier), a manufacturer provided ID and a third party unique ID.

19. The system as recited in claim 15 wherein one or more device identification numbers of the at least one device identification number are hashed.

20. The system as recited in claim 15 further comprising a hashing module, the hashing module hashing the at least one device identification number.

21. The system as recited in claim 15, wherein the one or more device details comprises one or more of http headers, browser user agent, IP address, screen resolution, location, browser plugins, flash version, JavaScript support, device manufacturer, device model, do not track status, device language and browser fonts.

22. The system as recited in claim 15, wherein user behavior information comprises one or more of time of the day, day of the week, date, number of sessions, average time per session, referral URL, user intent, user sentiment, gender, age, events, and category.

23. The system as recited in claim 15, wherein the match module correlates using one or more machine learning models.

24. The system as recited in claim 23 further comprising a training module, the training module providing training data to the one or more machine learning models, the training data including correlated communication devices with confirmed match probability.

25. The system as recited in claim 15 further comprising an API module, the API module providing an API for the third dataset.

26. The system as recited in claim 25, wherein the API module comprises a request module, the request module receiving a match request, the match request containing one of a cookie identification number and a device identification number.

27. The system as recited in claim 26, wherein the API module comprises a response module, the response module sending a response to the match request, the response comprising at least one of the one or more device numbers and the one or more cookie identification numbers correlated to the match request.

28. The system as recited in claim 27, wherein the response comprises match probability.

29. A computer program product for identifying a unique user across multiple communication devices, the computer program product comprising a non-transitory computer-readable medium having instructions embodied thereon, which when executed by a computer cause the computer to implement a method, the method comprising:
creating a first dataset of communication devices, the first dataset comprising at least one device identification number, one or more device details and one or more user behaviour information;
creating a second dataset of communication devices, the second dataset comprising one or more cookie identification numbers, one or more device details and one or more user behavior information;
correlating the first dataset and the second dataset to statistically determine a plurality of matching communication devices of the unique user, the correlation being based on the one or more device details and the one or more user behavior details; and,
storing the plurality of matching communication devices in a third dataset.
